(19) United States
(12) Patent Application Publication
(10) Pub. No.: US 2022/0294177 A1
(43) Pub. Date: Sep. 15, 2022

(54) ULTRAFAST PULSE LASER SYSTEM WITH MULTIPLE PULSE DURATION FAST SWITCH

(71) Applicant: IPG PHOTONICS CORPORATION, OXFORD, MA (US)

(72) Inventors: Alex YUSIM, Boston, MA (US); David CLARK, Westborough, MA (US); Igor SAMARTSEV, Westborough, MA (US); Joe ANTAS, Spencer, MA (US); Justin BARSALOU, Charlton, MA (US)

(73) Assignee: IPG PHOTONICS CORPORATION, OXFORD, MA (US)

(21) Appl. No.: 17/624,960

(22) PCT Filed: Jul. 9, 2020
(86) PCT No.: PCT/US20/41341

§ 371 Date: Jan. 5, 2022

Related U.S. Application Data
(60) Provisional application No. 62/871,878, filed on Jul. 9, 2019.

(51) Int. Cl. H01S 3/127; H01S 3/23; H01S 3/16

(52) U.S. Cl. CPC H01S 3/127; H01S 3/2316; H01S 3/1643; H01S 3/1603

(57) ABSTRACT

A CPA ultrashort pulse laser system is configured with a beam splitter dividing each ultrashort pulse from a seed laser into at least two replicas which propagate along respective replica paths. Each replica path includes an upstream dispersive element stretching respective replicas to different pulse durations. The optical switches are located in respective replica paths upstream or downstream from upstream dispersive elements. Each optical switch is individually controllable to operate at a high switching speed between “on” and “off” positions so as to selectively block one of the replicas or temporally separate the replicas at the output of the switching assembly. The replicas are so stretched that a train of high peak power ultrashort pulses each are output with a pulse duration selected from a fs ns range and peak power of up to a MW level.

### BACKGROUND OF THE DISCLOSURE

### Field of the Disclosure

The present invention relates to an ultrafast fiber laser system operative to controllably switch pulse duration at exceptionally high speed on the fly to perform different material processing tasks at higher productions speeds and reduces cost.

### Technological Background

Pulse duration of a laser is a critical parameter for optimum laser machining. Different materials often require widely disparate pulse durations for best machining quality and processing speed. As a result, laser processing of inhomogeneous, composite or multi-material or multi-layered components often requires multiple lasers operating at different pulse durations with prohibitively high cost. In addition, different desired types of micro-processing (such as drilling, trenching, marking, engraving, cutting, ablation, scribing, etc.) may also require a range of optimum pulse durations. It is advantageous to be able to perform multiple types of processing on the same component in order to reduce setup time and cost.

Ultrafast lasers, including among others solid state and fiber lasers, is a generic term for picosecond and femtosecond lasers which are widely used in laser processing of various materials. The pulse width of ultrafast lasers shorter than picoseconds is typically used for industrial applications, while longer pulses are used for commercial and industrial applications because of the high output power and high reliability. Such ultrashort pulse widths suppress heat diffusion to the surroundings of processed regions, which significantly reduces the formation of a heat-affected zone and enables ultrahigh precision micro- and nano-fabrication of a variety of materials. Owing to the ultrashort pulse width, the peak intensity of ultrafast lasers require heat treating at 10³ 10⁴ W/cm2, welding and cladding at 10⁵-10⁶ W/cm², and material removal 10⁷-10⁹ W/cm² for drilling, cutting, and milling. This level of high peak intensities creates nonlinear issues in the small diameter fiber core decreasing the quality of light and limiting its output power.

Numerous techniques have been developed to minimize undesirable consequences of high peak intensities in high power lasers including fiber laser. One of the known techniques is a chirped pulse amplification (CPA). Utilizing this technique, the extracted pulse energy is typically higher than that obtained by direct amplification. The CPA is based on chromatic dispersion and can be introduced with light propagating in optical materials including optical fibers via materials dispersion. It can also be introduced via angular dispersion in gratings or prisms. Chromatic dispersion in Bragg grating components uses the principle of interference in order to reflect different wavelengths of light at different locations in the grating. The convenience of Bragg reflectors is that the dispersion can be tailored or designed to the requirements such as dispersion compensation of other components.

Each light pulse guided through an optical media has a temporal shape that depends on its frequency content. For a pulse without a chirp the wider its frequency spectrum, the shorter the temporal width of the pulse. The chromatic dispersion or chirp is a temporal spreading over the wavelength spectrum. The pulse chirp is a foundation of CPA since the broader the pulse, the lower the peak intensity, the higher the threshold for nonlinear effects and, therefore, the greater the pulse amplification.

Thus, in CPA laser systems, the ultrashort pulses are first stretched in time using dispersion which leads a sufficiently reduced intensity enabling the subsequent amplification of the stretched pulses. In the final stage of CPA systems, a downstream dispersive element or compressor carries out the temporal compression of optically amplified pulses. Recompressing the higher pulse energy amplified pulses results in significantly higher peak powers at the system's output.

Many industrial applications of CPA laser systems require transform limited pulses which can be achieved by designing the zero or close to zero overall dispersion between various dispersive components in the laser system. The transform limit (or Fourier transform limit) is the lower limit for the pulse duration which is possible for a given optical spectrum of pulse. In other words, the transform-limited pulse has no chirp. If other than transform limited pulses are required, the components affecting the overall dispersion of the laser system should be properly adjusted to prevent full or zero compensation between these components.

An exemplary CPA fiber laser system includes a stretcher, such as a chirped fiber Bragg grating (CFBG), used to stretch optical pulses from an ultrafast optical laser seed. The system also includes a compressor, for example a chirped volume Bragg grating (CVBG), used to compress optical pulses after amplification. The pulses can be increased in size by one of two methods after the pulse compressor. In accordance with one method, the optical spectral width of the optical pulses can be adjusted by decreasing the spectral width of the CFBG. The other method is to use mismatched dispersion between the CFBG and CVBG to create chirped optical pulses.

Fine tuning of the pulse duration and pulse shape can be accomplished by a pulse shaper. One example of the pulse shaper such as an CFBG is disclosed in U.S. Provisional Patent applications 62/782,071 and 62/864,834. The tuning of the CFBG by increasing or decreasing the pulse duration is limited by the optical bandwidth and the amount of dispersion tunability. It was demonstrated that such a pulse can be tuned from <1 ps to 25 ps using the CFBG. However, the speed of tuning was limited to 20 seconds due to the design of the shaper (heating different portions of the CFBG). Faster pulse shapers, such as moveable gratings, are available. However, a movable grating is bulky and its tunability is slower than that of acousto-optical pulse shapers such as a commercially available Dazzler.

It is therefore desirable to use a single laser source that can switch pulse duration on the fly to reduce setup time, complexity and cost of the laser system.

A further need exists for a compact industrial grade laser configuration with fast switching between pulse durations for different laser processing applications at high speed.

### SUMMARY OF THE DISCLOSURE

This invention addresses the issue of fast switching between femtosecond (fs), picosecond (ps) and nanosecond (ns) pulse lasers in a single laser configuration utilizing a chirped pulse amplification (CPA) technique.

The inventive chirp pulse amplification (CPA) laser system in its basic configuration includes an ultrafast seed laser which outputs a train of ultrafast pulses along a light path coupled into a pulse duration switch assembly. The latter is operative to split each pulse into two or more replicas which have pulse temporal and spectral contents modified so that only one of the replicas continues propagation along the path. The guided replica is then amplified and again temporally treated in a downstream dispersion element so that the CPA system outputs high energy pulses in a fs ns duration range.

The pulse duration switch assembly is configured with at least one beam splitter guiding two replicas with respective power fractions of the split pulse along respective replica paths. The replicas each interact with an upstream dispersive element modifying the temporal content of the replica. In addition, spectral filters may be applied to respective replica paths so as to change the spectral content of the replica. Alternatively, a single upstream dispersive element can be used for modulating a pulse duration and spectral pulse width of each replica.

To have the desired duration of the pulses at the output of the CPA system, two optical switches are coupled into respective replica paths and individually controlled so that one of the replicas is blocked from a further propagation. Any of high speed acousto-optic modulator (AOM), electro-optic modulator (EOM), MEMS-based switch and others can be readily incorporated in the inventive structure.

The individual control of optical switches allows both of them to be switched simultaneously to the “on” position. This may be useful for industrial applications requiring a sequential irradiation of the surface to be processed by two pulses with different pulse durations. For example, a ps or ns pulse initially heats the irradiated surface such that a subsequent fs pulse, which is incident on the heated surface, forms a hole. The sequential irradiation by different pulses is accomplished by increasing the optical path length of one of the replica paths. This structural feature may be used with all of the examples of the inventive CPA system disclosed above. If, however, only a single pulse is required, both replica paths may have a uniform optical length.

In the inventive CPA laser system, the upstream dispersive elements apply respective chirps to the replicas. The upstream dispersive elements are selected from a FBG, CFBG, length of fiber, bulk optics, prisms etc., and located along respective replica paths upstream or downstream from respective optical pulse switches.

By tailoring the chromatic dispersion of the upstream and downstream dispersive elements one can generate pulse durations in a femtosecond-nanosecond range. For example, a femtosecond laser can be configured by using a positive dispersion CFBG pulse stretcher and a nearly matched negative dispersion CVBG pulse compressor or vice versa. A more mismatched CFBG and CVBG pair can be used in picosecond lasers. For the nanosecond case, the CFBG can have the same sign of dispersion as the CVBG, i.e., positive or negative dispersion, to stretch the pulses further after amplification. A typical CFBG can stretch the pulse to a 0.5-1 ns range. A VBG with the same dispersion sign would end up stretching the pulses to 1-2 ns.

The CPA laser system as disclosed above is configured with at least one beam coupler in optical communication with downstream ends of respective replica paths. Functionally, the beam coupler guides the selected replica towards the downstream end of the CPA system. The beam splitter and beam coupler each can be a bulk optic component or fiber-based component, wherein the bulk optic component includes a dielectric coated optic, while the fiber-based component is a directional fused fiber coupler.

The CPA laser system as disclosed above may additionally have at least one more beam splitter and at least one second beam coupler defining therebetween a third replica path for a third replica with spectral and pulse duration contents which are different from those of the other replicas. The third replica path is structurally analogous to the above disclosed two replica paths and includes a third upstream dispersive element and third optical switch. Optionally, a third spectral filter can be applied to the third replica path.

### BRIEF DESCRIPTION OF THE DRAWINGS

The above and other features of the inventive system will become more readily apparent from the following specific description which is accompanied by the following drawings, in which:

FIG. 1 illustrates the inventive optical schematic of the disclosed system;

FIG. 2 illustrates the optical schematic of the pulse duration switch of FIG. 1;

FIG. 3 illustrates a modification of the optical schematic of FIG. 1;

FIG. 4 is the optical schematic of the pulse duration switch of FIG. 3;

FIG. 5 is the optical schematic illustrating an optical modification of FIG. 1;

FIG. 6 is the optical schematic of the pulse duration switch of FIG. 5;

FIG. 7 is the optical schematic of another modification of FIG. 1;

FIG. 8 is the optical schematic of the pulse duration switch of FIG. 7;

FIG. 9 is the optical schematic of still another modification of FIG. 1;

FIG. 10 is the optical schematic of the pulse duration switch of FIG. 9;

FIG. 11 is the optical schematic similar to one of FIG. 9;

FIG. 12 is the pulse duration switch of FIG. 11 based on CFBG-based stretcher;

FIG. 13 is the optical schematic of another modification of FIG. 1;

FIG. 14 is the pulse duration switch of FIG. 13 based on bulk stretcher;

FIG. 15 is the optical schematic of any of FIGS. 1, 3, 5, 7, 9, 11 and 13 with a second harmonic generator (SHG);

FIG. 16 is the optical schematic of the pulse switcher of FIG. 15;

FIG. 17 is the optical schematic of any of FIGS. 1, 3, 5, 7, 9, 11, 13 and 15 in combination with the SHG and higher harmonic conversion mechanism;

FIG. 18 is the optical schematic of the pulse switcher of FIG. 17;

FIG. 19 is an example of the optical schematic of any of FIGS. 1, 3, 5, 7, 9, 11, 13, 15 and 17;

FIG. 20 is the optical schematic of the pulse duration switch of FIG. 19;

FIGS. 21A-C and 22A-C each illustrate the operation of fast pulse duration switching assembly in accordance with any of the schematics illustrated in FIGS. 1 20.

### SPECIFIC DESCRIPTION

In the figures, each identical or nearly identical component that is illustrated in various figures is represented by a like numeral. For purposes of clarity, not every component may be labeled in every figure.

The inventive laser system is based on a chirped pulse amplification laser technique and includes a high speed pulse duration switch assembly which is operative to pass one or more pulse replicas with the desired duration while blocking or delaying the output with the other pulse durations. In the inventive laser system, the pulse duration is set by a proper dispersion management and, optionally, controllable adjustment of the spectral width of dispersive elements such as a stretcher and compressor which are further referred to as upstream and downstream dispersion elements, respectively. Several schematics illustrating the inventive concepts is discussed hereinbelow.

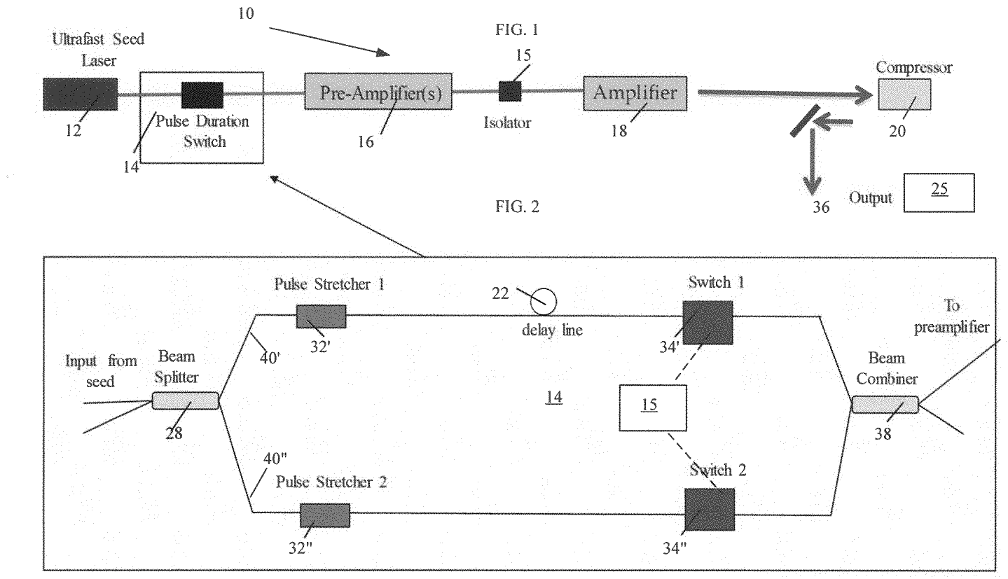

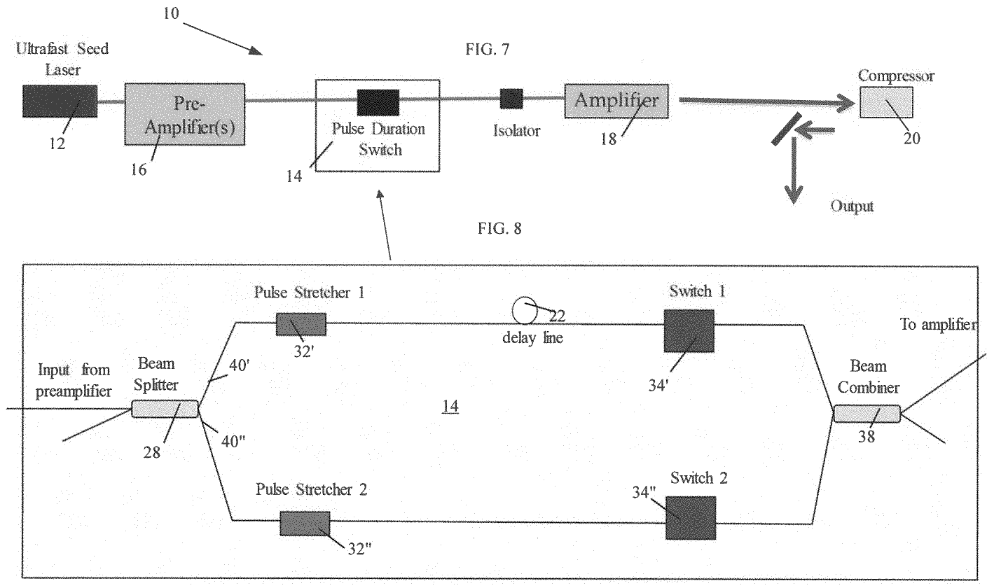

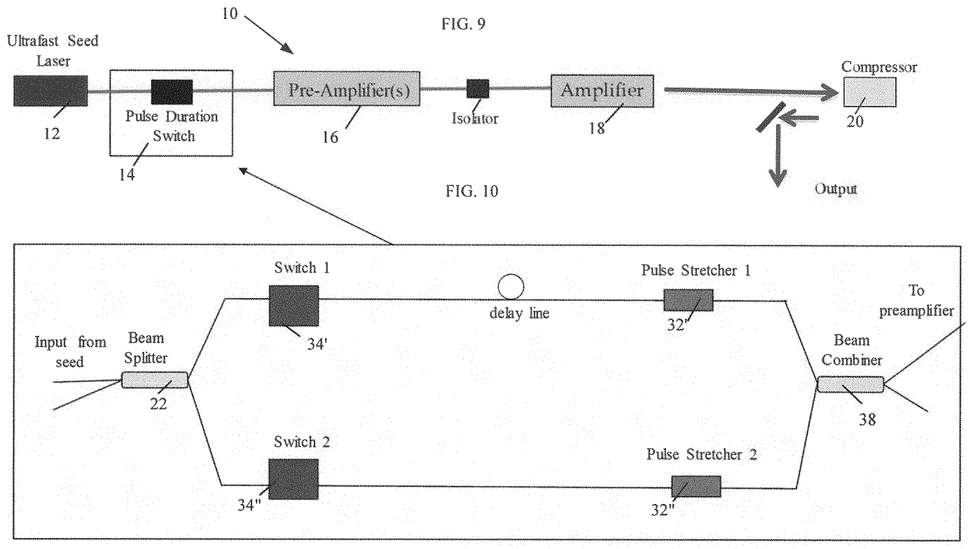

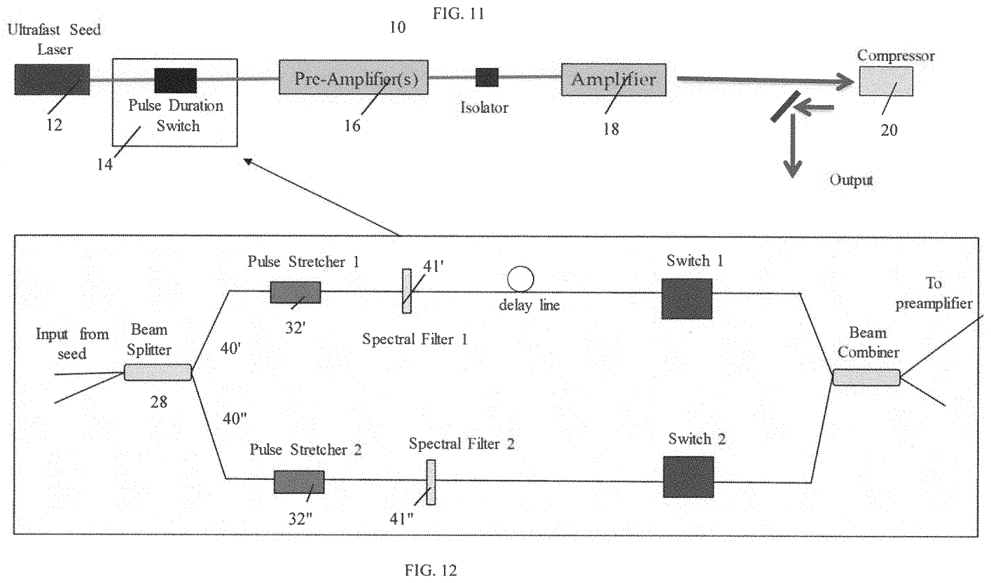

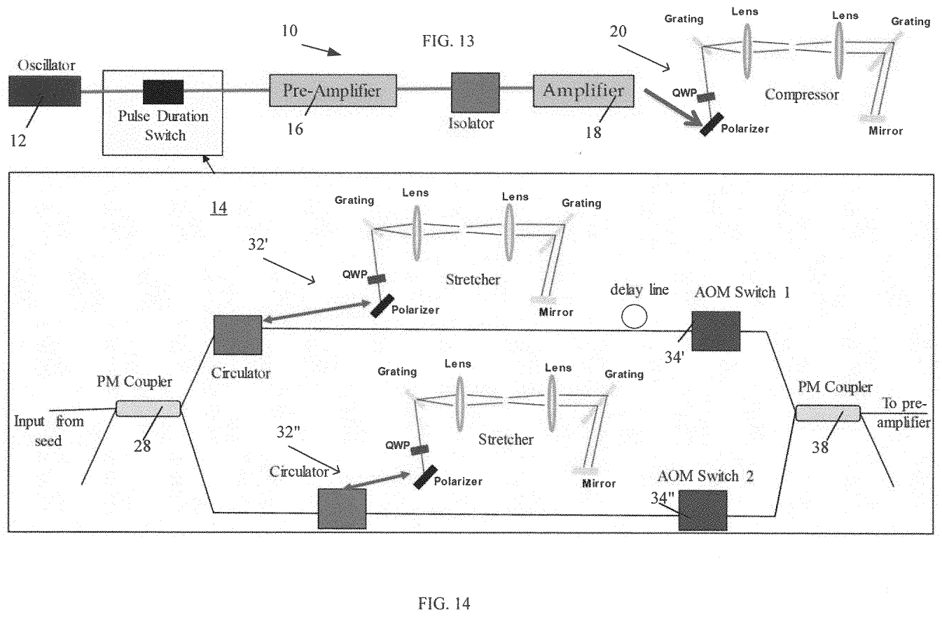

Referring to FIGS. 1, 3, 5, 7, 9, 11, 13, 15 and 17, a CPA ultrashort laser system 10 may include only fiber components, bulk optic components or any combination of fiber and bulk optic components. The laser system 10 includes an ultrashort pulse seed laser or seed 12 which can operate in a standard pulsed regime or burst regime. The standard regime is characterized by a train of ultrashort ps fs pulses at a uniform pulse repetition rate duration range. In the burst regime the train of pulses is output at a non-uniform rate with each burst including a series of pulses. Regardless of the selected regime, pulses are incident on a pulse duration switch assembly 14 operative to output temporally stretched and spectrally altered pulse replica.

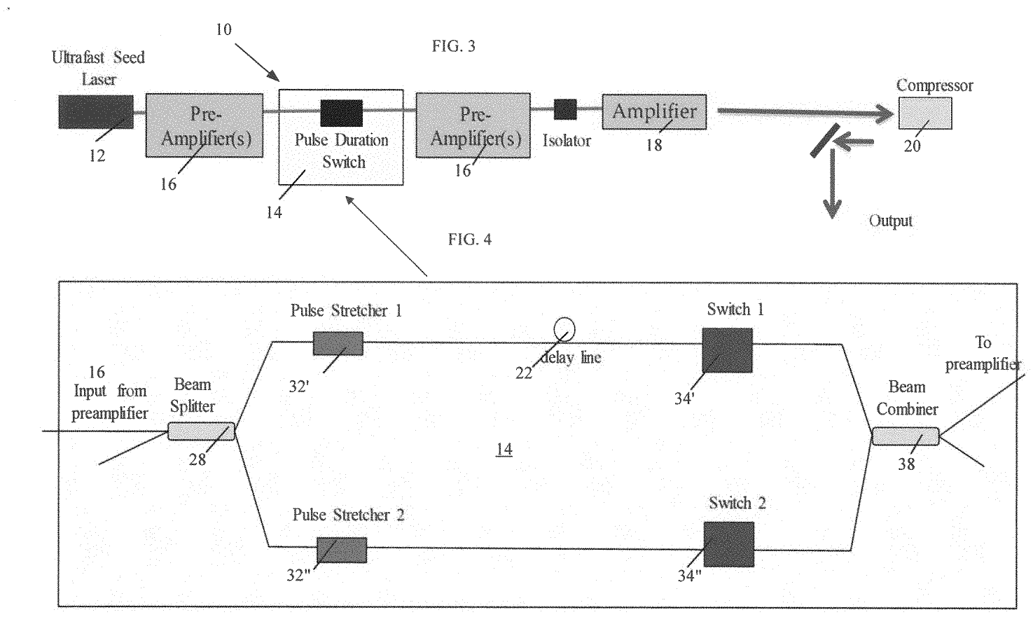

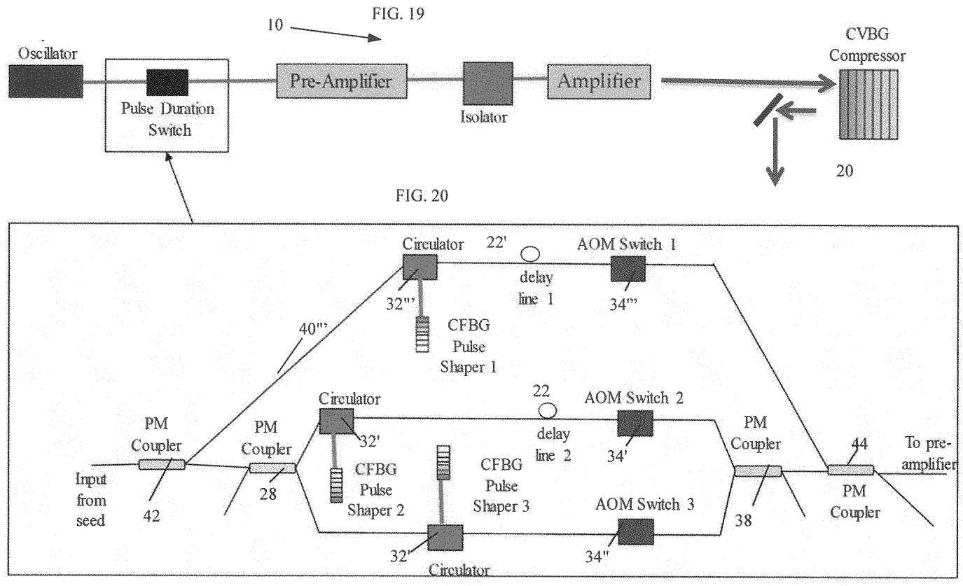

As illustrated in FIGS. 1, 9, 11, 13, 15, 17 and 19, a single or multiple amplifiers 16, 18 amplify the optically treated pulses output from switch assembly 14. Alternatively, as shown in FIGS. 3, 5 and 7, at least one of pre-amplifiers 16 may be located upstream from pulse duration switch 14. However, in accordance with the CPA method, amplifier or booster 18 is always located downstream from pulse duration switch 14.

The amplified pulses are further coupled into a downstream dispersive component 20 tuned to provide amplified pulse replicas 36 with the desired duration. The desired pulse duration may be as low as 5 fs and as long as a few ns, whereas the high peak power range extends between a few hundred watts and a few MWs.

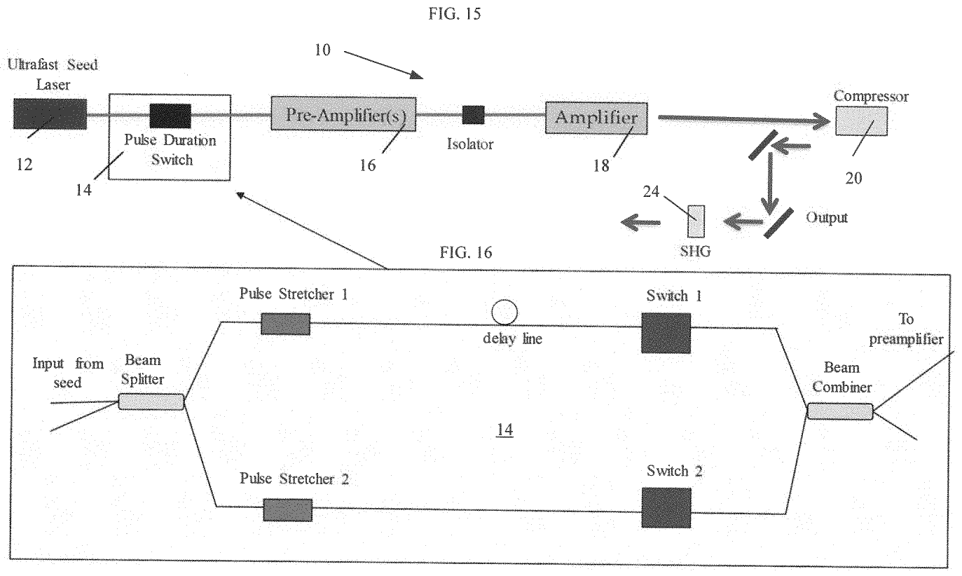

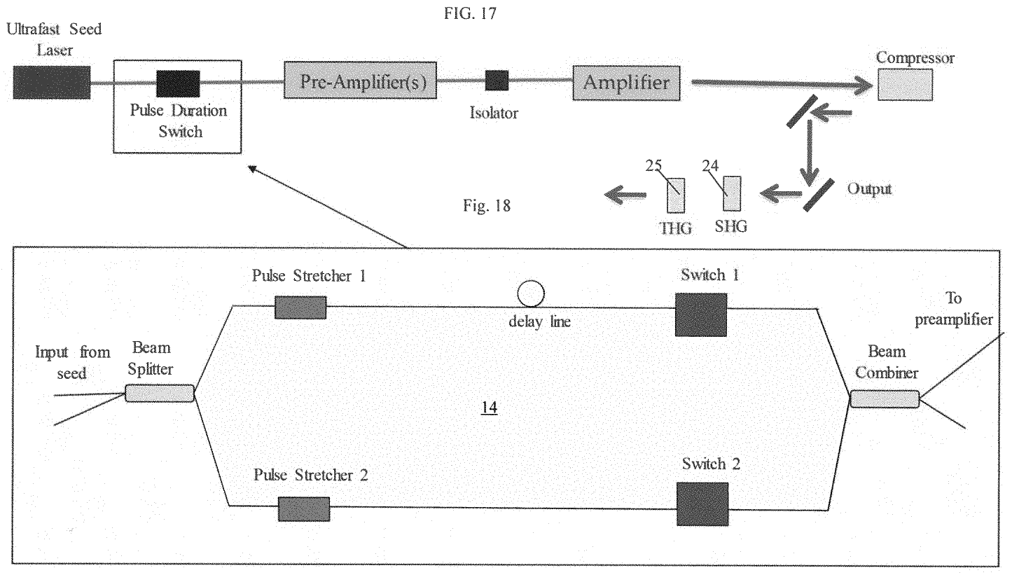

Optionally, CPA laser system 10 may be configured with a frequency conversion unit downstream from dispersion element or compressor 20. The frequency conversion unit may include a second harmonic generator (SHG) 24 (FIG. 15) only or a combination of SHG and at least one higher harmonic generator (HHG) 25 (FIGS. 1 and 17). If needed, the frequency conversion unit can be incorporated in system 10 shown in any of the above-listed figures. The second and higher harmonic generators each include any of known nonlinear crystals with each crystal being optimized to selectively convert one of the replicas for a desired converted pulse duration. The optimization can be accomplished by selecting a crystal length, crystal temperature or crystal axis or a combination of the crystal length, temperature and axis.

An isolator 15 preventing propagation of back-reflected light can be installed in any of the schematics shown in respective figures referred to above. Furthermore, if transform limited pulses are desired at the output of system 10, a multiphoton intrapulse interference phase scan (MIIPS) shaper, can be incorporated in any of the discussed configurations of system 10 after downstream dispersion element 20. The operation of MIIPS pulse shaper is disclosed in PCT/US2018/025152 fully incorporated herein by reference.

Referring specifically to FIG. 2, pulse duration switch assembly 14 is configured with a beam splitter 28 receiving ultrashort pulses from seed 12 and dividing each ultrashort pulse into two or more pulse replicas with equal or different power fractions. Depending on the overall design of CPA system 10, beam splitter 28 may have a bulk optic structure or fiber structure. The bulk optic may include, for example, a dielectric coated optic, while the fiber-based structure is a directional fused fiber coupler. The fiber-based beam splitter may be configured as 1×N and 2×N splitter and have either fibers fixedly attached to respective ports (pigtail style) or with receptacles on each port that one can plug a fiber into (receptacle style).

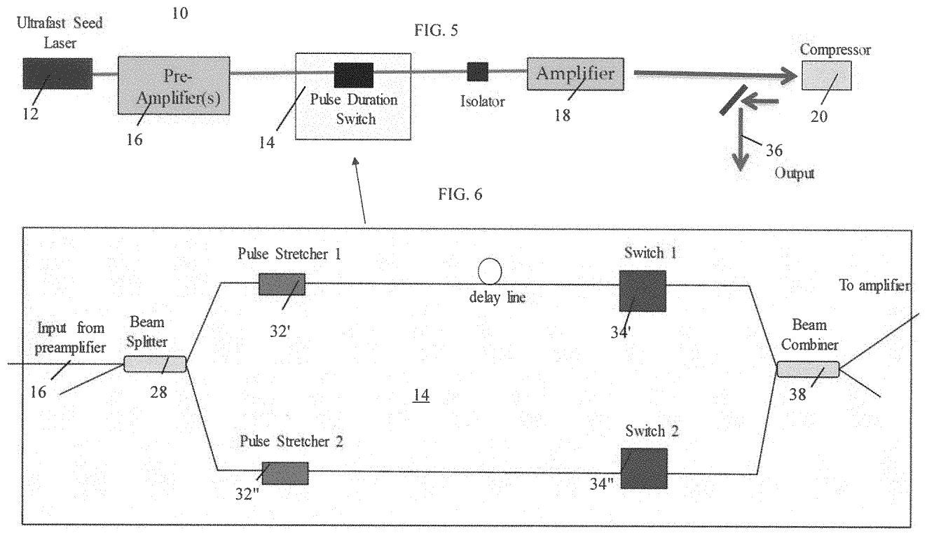

The schematic of FIGS. 2, 4, 6, 8, 10, 12, 16, 18 and 20 is an all fiber structure in which two replica paths are defined by two single mode (SM) fibers 40′ and 40″ respectively. The fiber that is used in the inventive system 10 is selected among regular fibers, polarization maintaining fibers, specialty fibers and large mode area (LMA) fibers. Regardless of the light guiding media, i.e., free space or fiber or a combination of free space and fiber, each replica path includes an upstream dispersive element 32′/32″ and optical switch 34′/34″ with one exception when a single upstream dispersive element is placed after switch 14 as disclosed hereinbelow in reference to FIG. 10.

The relative position of upstream dispersive element 32′, 32″ and optical switch 34′, 34″ applied to each replica path can vary. The switches 34′, 34″ are coupled to respective outputs of upstream dispersive elements 32′ and 32″. FIG. 10 illustrates switches 34′ and 34″ located upstream from respective upstream dispersive element 32′, 32″.

Ultrashort pulses emitted from seed laser 12 (FIG. 1) each have a high peak power of up to a kW or even higher. Amplifying these pulses can lead to devastating structural consequences. High energy ultrashort pulses amplified in a gain media, such as fiber amplifiers, also cause the onset of nonlinear effects limiting the output power and decreasing the quality of light. The CPA technique is directed to minimize these deleterious effects which are frequently manifested in fs and ps laser systems by extending the duration of ultrashort pulses. This is accomplished here by upstream dispersive elements or pulse stretchers 32′ and 32″ which are configured to temporally stretch ultrashort pulses. As a result, upstream dispersive elements 32′ and 32″ introduce wavelength dependent optical delays to generate frequency chirp for temporal stretching. Hence the term frequency chirp means temporal arrangement of the frequency components of the ultrashort laser pulse. The chirps introduced by upstream dispersive elements 32′, 32″ to respective replicas are different from one another. The chirps are selected so that the stretched replicas are converted into ultrashort pulses with the desired pulse duration upon interacting with downstream dispersive element 20 (FIG. 1). The desired duration of the output ultrashort pulses is selected among fs, ps and ns pulses. It is also possible to output a combination of pulses with respective pulse durations different from one another. For example, one output pulse duration is in a ps range, while the other is in a fs range.

The dispersion has different positive and negative signs. In a medium with the positive dispersion, the higher frequency components of the pulse travel slower than the lower frequency components, and the pulse becomes positively-chirped or up-chirped, increasing in frequency with time. In a medium with negative dispersion, the higher frequency components travel faster than the lower ones, and the pulse becomes negatively chirped or down-chirped, decreasing in frequency with time. Dispersive gratings provide large stretching factors and by using diffraction gratings, ultrashort optical pulses can be stretched to more than 1000 times.

Structurally, upstream fiber dispersion element 32′, 32″ may include any of prism, bulk optic, length of fiber, volume Bragg grating (VBG), uniform fiber Bragg grating (FBG) or chirped FBG (CFBG) configurations. The FBG is a periodic structure that resonates at one Bragg wavelength. In contrast, the Bragg wavelength varies along the grating in the CFBG, since each portion of the latter reflects a different spectrum. Thus, the key characteristic of the CFBG is the fact that the overall spectrum depends on the temperature/strain recorded in each section of CFBG as opposed to the strain or temperature applied on the whole grating length of FBG. FIG. 20 shows a typical CFBG module design based on CFBG and circulator.

The downstream dispersion element 20 (FIG. 1) can be configured identically to the upstream dispersive elements. Alternatively, the configurations of respective upstream and downstream dispersive elements can differ from one another. For example, upstream dispersive elements 32′, 32″ may have a CFBG configuration, whereas downstream dispersive element 20 is a VBG. A variety of combinations including differently configured dispersive elements can be easily implemented in any of the illustrated schematics by one of ordinary skill in the ultrashort laser art.

The optical switch 34′, 34″ is used to shut off the optical power for any of the undesired replica paths thus allowing only one replica with the desired pulse duration to propagate towards downstream dispersive element 20. The optical switch may have different configurations. For example, it can be a MEMs based switch, electro-optic switch such as lithium niobate modulator, or an acousto-optic switch such as an AOM. The specific configuration of optical switch 34′, 34″ depends on various factors. The key consideration for selecting the desired switch, however, is a switching time which should be fast as possible. The AOM is perhaps the fastest switching device. In the tested configurations of CPA laser system 10, a minimal switching time of a fiber coupled AOM was determined to be in a 20-30 ns range. This time interval is believed to be a record time which is so important in micro-processing of multi-layer or multi-material parts such as semi wafers, PCBs, Flex Circuits that require optimally different pulse durations. The speed at which inventive CPA system 10 is operative to switch pulse durations is one of the key advantages of this invention—essentially it is able to offer the functionality of multiple lasers in one single laser. The switching operation is controlled by standard electronics 15 with appropriate speed are required to switch on and off optical switches 34′ and 34″.

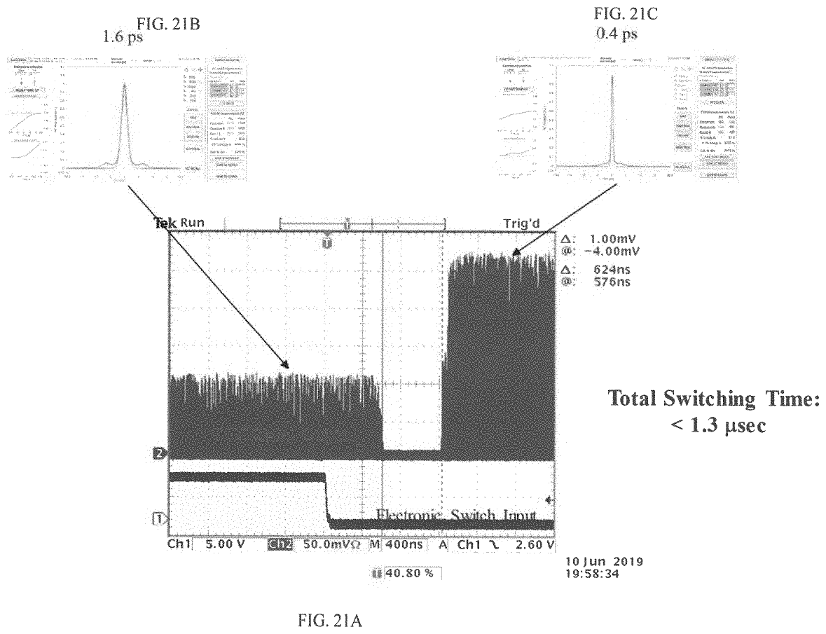

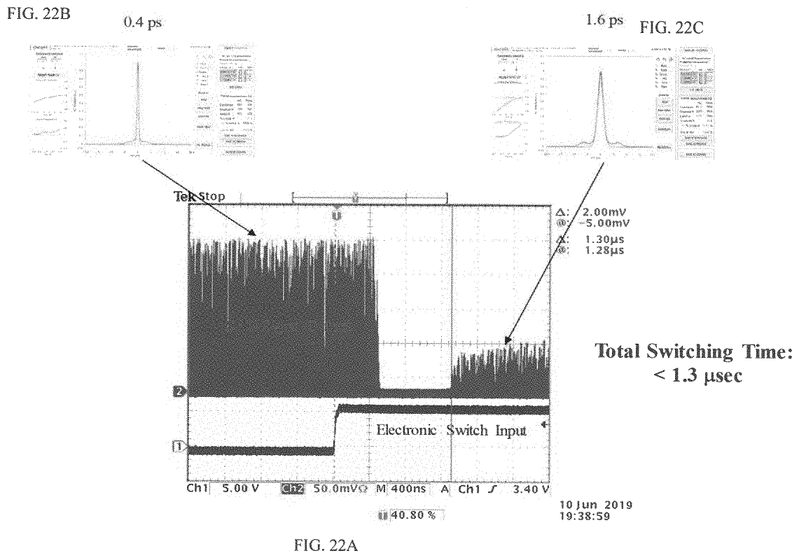

FIGS. 21A-C illustrate the total switching time of the utilized optical switches in CPA 10 switching from 1.6 ps or 0.4 ps, whereas FIGS. 22A-C illustrate the switching in a reverse order from 0.4 ps to 1.6 ps. The switching time is the same and less than 1.3 microsecond. Recent experiments demonstrated the inventive schematic utilizing the switches operating at a switching time of less than 200 ns which can be further decreased to a ps range.

As mentioned above, it is also possible to have multiple pulses at the output of CPA system 10 with different pulse durations by utilizing differently configured upstream dispersion elements 32′ and 32″ and using both switches 34′ and 34″ which both can be switched to the “on” state. The pulse separation at the output of switch assembly 14 can be controlled by introducing a delay fiber loop 22 increasing the optical length of one of replica paths while keeping the optical length of other(s) replica paths intact. All optical paths may be configured with respective delay loops 22 dimensioned to provide the replica paths with respective optical lengths which differ from one another. It would allow creating a burst of pulses with different pulse durations or same pulse duration that are reconfigurable in real time. For example, one can operate the seed in the burst mode such as to keep n number of pulses in each optical path, then switch the seed to n−1 pulse burst, n−2 pulse burst, etc.

The optical paths are combined into a single optical path by using a beam combiner 38. The beam combiner can be an optical component configured similarly to beam splitter 28. For bulk optics this may be a dielectric coated optic. For fiber based system, a directional fused fiber coupler can be incorporated in CPA system 10. Differently configured beam splitter and combiner components may be implemented in every schematic shown in FIGS. 1, 3, 5, 7, 9, 11, 13, 15, 17 and 19.

FIGS. 10, 14 and 20 each show additional structural elements that require a more detailed disclosure. As one of ordinary skill readily understands, all of the below disclosed additional components can be easily incorporated in all schematics of this application.

Turning specifically to FIG. 12, inventive CPA laser system 10 may be optionally configured with spectral filters 41′, 41″ applied to respective replica paths 40′ and 40″. The FBG elements are known to have the relatively narrow reflection bandwidth which somewhat limits the pulse duration. As known in the laser arts, the shorter the spectral pulsewidth of stretched replicas, the longer the duration of output recompressed ultrashort pulses. Thus, spectral filters 41 may be used as additional pulse shapers leading to more refined pulse shape. Configured to adjust replicas incident thereupon to respective and different spectral pulsewidths, spectral filters 41 can be located upstream or downstream from respective upstream dispersive elements 32′, 32″. Another structural possibility includes stretching ultrashort pulses upstream from beam splitter 28 and, after splitting the stretched pulse into two replicas, cut respective bandwidths.

FIG. 14 illustrates inventive CPA laser system 10 having a hybrid fiber/bulk optic structure of pulse duration switch assembly 14. As shown, upstream dispersive elements 32′, 32″ have a bulk-optic configuration including two reflection gratings, two lenses, polarizer, quarter wave plate and a retro-mirror pair. The free space configuration of elements 32′ and 32″ may be selected from the structures including Martinez and Treacy configurations.

Referring specifically to FIG. 20, a multi-replica path CPA laser system 10, in addition to previously disclosed two replica paths 40′ and 40″, has a third replica path 40′″. The latter extends between a third beam splitter 42 and third combiner 44 with beam splitter 42 being located between seed 12 and splitter 28, and third coupler 44 being coupled between optical combiner 38. The upstream dispersive element 32′″, optional delay loop 22′ and optical switch 34′″ located along third replica path 40′″ as is disclosed in reference to the previously discussed schematics. The addition of third replica path provides the possibility of using three replicas stretched to respective different pulse durations which could be selectively compressed to the desired pulse duration in downstream dispersive component 20. The two and tree replica paths are just a couple of examples of the inventive pulse duration switch. Accordingly, any reasonable number of splitters and combiners defining more than three replica paths 40′, 40″ and 40′″ is covered within the scope of this invention.

Revisiting FIGS. 1, 3, 5, 7, 9, 11, 13, 15, 17 and 19, ultrafast seed 12 is not limited to any particular type or configuration and selected, among others, from mode-locked diode pump bulk lasers, mode locked fiber and semiconductor lasers. If seed laser 12 has a fiber configuration, an exemplary structure is disclosed in U.S. Pat. No. 10,193,296 fully incorporated herein by reference.

The booster 18 can be selected from a variety of configurations including fiber, rare earth ion-doped yttrium aluminum garnet (YAG), disk and other amplifier configurations. Regardless of the configuration, booster 18 should provide the replica or replicas incident thereupon with a high gain. Peak powers reaching MW levels are particularly beneficial for CPA system 10 provided with frequency conversion stages. Exemplary configurations of fiber booster 18 are disclosed in U.S. Pat. Nos. 7,848,368, 8,068,705, 8,081,667 and/or 9,667,023, whereas the YAG configuration is disclosed in US Patent Application Publication 201662428628 all incorporated herein by reference.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

1. A chirp pulse amplification (CPA) laser system, comprising:
spaced apart ultrafast seed laser, outputting a train of pulses, and a booster;
at least one beam splitter coupled to an output of the seed laser and configured to split each pulse incident thereupon into two replicas, the replicas propagating along respective replica paths while being chirped to a duration greater than that of the pulse; and
two pulse switches located along respective replica paths and each controllable to alternate between an “on” position in which the replica unimpededly propagates towards the booster, and an “off” position in which a propagation of the replica is blocked.

2. The CPA laser system of claim 1 further comprising two upstream dispersive elements located along respective replica paths upstream or downstream from respective pulse switches, the dispersive elements being configured to provide respective two replicas with a uniform or different chirp.

3. The CPA laser system of claim 1, wherein the replicas paths have respective optical path lengths which are equal to or different from one another.

4. The CPA of claim 1, wherein the optical switches are controllable so that while one of the optical switches is in the “off” position”, the other optical switch is in the “on” position.

5. The CPA laser system of claim 1, wherein the two optical switches both are either in the “on” or “off” position, one of the optical switches being located along the replica path with the optical path length which is greater than that of the other replica path so as to provide a temporal separation between the replicas downstream from the optical switches when two optical switched are in the “on” position.

6. The CPA laser system of claim 1 further comprising two spectral filters located along respective replica paths and having respective bandwidths which are different from one another.

7. The CPA laser system of claim 1 further comprising at least one beam coupler in optical communication with downstream ends of respective replica paths, the beam splitter and beam coupler each being a bulk optic component or fiber-based component, wherein the bulk optic component includes a dielectric coated optic, while the fiber-based component is a directional fused fiber coupler.

8. The CPA laser system of claim 2 further comprising a downstream dispersive element in optical communications with downstream of respective replica paths so to receive the propagating replica or replicas, each of the upstream dispersive elements and downstream dispersive element generating respective dispersions which are equal to or different from one another and having respective matching or opposite signs.

9. The CPA laser system of claim 2, wherein the upstream dispersive elements each apply such a chirp to the replica that, upon impinging of the unblocked replica upon the downstream dispersive element, it is operative to output an ultrashort pulse with a duration from a fs ns range.

10. The CPA laser system of claim 1, wherein the ultrafast seed laser has a configuration selected from the group consisting of fiber lasers, disk and semiconductor lasers, the fiber oscillator having a Fabry-Perrot or ring architecture.

11. The CPA laser system of claim 1, wherein the booster is a rare earth ion-doped fiber amplifier or rare earth ion-doped yttrium aluminum garnet (YAG) amplifier.

12. The CPA laser system of claim 8, wherein upstream and downstream dispersion elements each are a fiber Bragg grating (FBG), chirped FBG, volume Bragg grating (VBG), prism or bulk grating.

13. The CPA laser system of claim 1 further comprising:
at least one second beam splitter located between and in optical communication with the seed laser and one beam splitter, at least one second beam coupler between the one beam coupler and booster, wherein the second beam splitter and second coupler are in optical communication with one another defining at least one third optical path, and
a third upstream dispersive element and third optical switch located along the third optical path and in optical communication with one another.

14. The CPA laser system of claim 13, wherein the third dispersive element is operative to generate a third chirp different from or same as the chirps generated by the two upstream dispersive elements.

15. The CPA laser system of claim 14 further comprising an additional spectral filter having a bandwidth different from the bandwidths of respective spectral filters in one and other optical paths.

16. The CPA laser system of claim 1, wherein the pulse switches are each an acousto-optic modulator (AOM), electro-optic modulator (EOM), or MEMS-based switch operating with minimal switching time in a ps-ns range.

17. The CPA laser system of claim 1 further comprising one or more high harmonic generation nonlinear crystals downstream from the downstream dispersive element, the nonlinear crystals each being optimized to selectively convert one of the replicas for a desired converted pulse duration.

18. The CPA laser system of claim 17, wherein the nonlinear crystals each are optimized by selecting a crystal length, crystal temperature or crystal axis or a combination of the crystal length, temperature and axis to frequency convert the selected replica.
